(19) United States
(12) Patent Application Publication
(10) Pub. No.: US 2009/0318004 A1
(43) Pub. Date: Dec. 24, 2009

(54) LOW PROFILE PHOTOVOLTAIC CONNECTOR

(75) Inventor: Dave COURS, Dalton, PA (US)

Correspondence Address: TYCO TECHNOLOGY RESOURCES, 4550 NEW LINDEN HILL ROAD, SUITE 140, WILMINGTON, DE, 19808-2952, US

(73) Assignee: TYCO ELECTRONICS CORPORATION, Berwyn, PA (US)

(21) Appl. No.: 12/144,085

(22) Filed: Jun. 23, 2008

(51) Int. Cl. H01R 13/62

(52) U.S. Cl. 439/304

(57) ABSTRACT

A low profile PV (LPPV) connector for placement in space restricted areas. The connector includes a plug and receptacle for interconnecting PV solar arrays. The LPPV connector may be a locking connector or a non-locking connector. An extraction tool must be used to unlock an engaged locking connector. The LPPV connector includes a plug and a receptacle that are waterproof when mated.

### FIELD OF THE INVENTION

The present invention is directed to a connector for photovoltaic (PV) systems, and more particularly to a low profile connector in a PV system that provides a solution for space-restricted areas.

### BACKGROUND OF THE INVENTION

Photovoltaic (PV) modules, or PV arrays, produce electricity from solar energy. Electrical power produced by PV modules reduces the amount of energy required from non-renewable resources such as fossil fuels and nuclear energy. Significant environmental benefits are also realized from solar energy production, for example, reduction in air pollution from burning fossil fuels, reduction in water and land use from power generation plants, and reduction in the storage of waste byproducts. Solar energy produces no noise, and has few moving components. Because of their reliability, PV modules also reduce the cost of residential and commercial power to consumers.

PV cells are essentially large-area semiconductor diodes. Due to the photovoltaic effect, the energy of photons is converted into electrical power within a PV cell when the PV cell is irradiated by a light source such as sunlight. PV cells are typically interconnected into solar modules that have power ranges of up to 100 watts (W) or greater. For large PV systems, special PV modules are manufactured with a typical power range of up to several hundred watts. A PV module is the basic element of a (PV) power generation system. A PV module has many solar cells interconnected in series or parallel, according to the desired voltage and current parameters. PV cells are connected and placed between a polyvinyl plate on the bottom and a tempered glass on the top. PV cells are interconnected with thin contacts on the upper side of the semiconductor material. The typical crystalline modules power ranges from several watts to two hundred watts per module.

In the case of facade or roof systems, the PV system may be installed during construction or added to the building after it is built. Roof systems are generally lower powered systems, e.g., 10 kW, to meet typical residential loads. Roof-integrated PV systems may consist of different module types, such as crystalline and micro-perforated amorphous modules. Roof-integrated PV systems are integrated into the roof such that the entire roof or a portion thereof is covered with PV modules, or they are added to the roof later. PV cells may be integrated with roof tiles or shingles.

PV modules or arrays require specially designed devices adapted for interconnecting the various PV modules with each other, and with electrical power distribution systems. PV connection systems are used to accommodate serial and parallel connection of PV arrays. In addition to connection boxes, a PV connection system includes connectors that allow for speedy field installation or high-speed manufacture of made-to-length cable assemblies. Connectors or connection boxes may be required to receive specialized cable terminations from PV modules, with power diodes inside for controlling current flow to the load. PV modules may be required in areas with tight space restraints and requirements, requiring the size of the PV module to be minimized. U.S. patent application Ser. No. 11/865,883 entitled “LOW PROFILE PHOTOVOLTAIC (LPPV) BOX”, filed on Oct. 2, 2007, describes a low profile PV junction box for use with PV modules.

Therefore, there is a need for a low profile PV (LPPV) connector that allows for the placement of PV arrays in compact areas.

### SUMMARY OF THE INVENTION

The present invention is directed to a low profile connector including a plug and a receiver. The plug has a strain relief, a plug body, a male connection and a cable, and the receptacle has a strain relief, a receptacle body and a receiver. The plug is matable with the receptacle to form an electrical connection and when the plug and receptacle are mated, the plug is not removable from the receptacle. The plug and the receptacle have a vertical profile not greater than a width of the cable.

Another embodiment of the present invention is directed to a low profile connector including a plug and a receptacle. The plug and receptacle mate and form an electrical connection. The plug includes a strain relief, a plug body, a male connection and a cable. The plug body has at least one latch. The receptacle includes a strain relief, a receptacle body and a receiver. The receiver has at least one ledge that engages with the at least one latch. The plug and the receptacle have a vertical profile not greater than a width of the cable.

An advantage of the present invention is that the low profile PV junction connector allows a PV solar array to be placed in restricted spaces.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 shows a perspective view of a plug and a receptacle of a locking low profile PV connector in an unmated position.

FIG. 2 shows a side view of the plug and receptacle of FIG. 1.

FIG. 3 shows a cross-sectional view of the plug and receptacle in a mated position.

FIG. 4 shows a perspective view of the mated connector and an extraction tool.

FIG. 5 shows a perspective view of a plug and a receptacle of a non-locking low profile PV connector in an unmated position.

FIG. 6 shows a perspective view of a plug and a receptacle of the non-locking connector in a mated position.

FIG. 7 shows a cross-sectional view of the non-locking connector.

FIG. 8 shows a perspective view of a plug and a receptacle of an alternate embodiment of a low profile PV connector.

FIG. 9 shows the connector of FIG. 8 in communication with solar arrays.

### DETAILED DESCRIPTION OF THE INVENTION

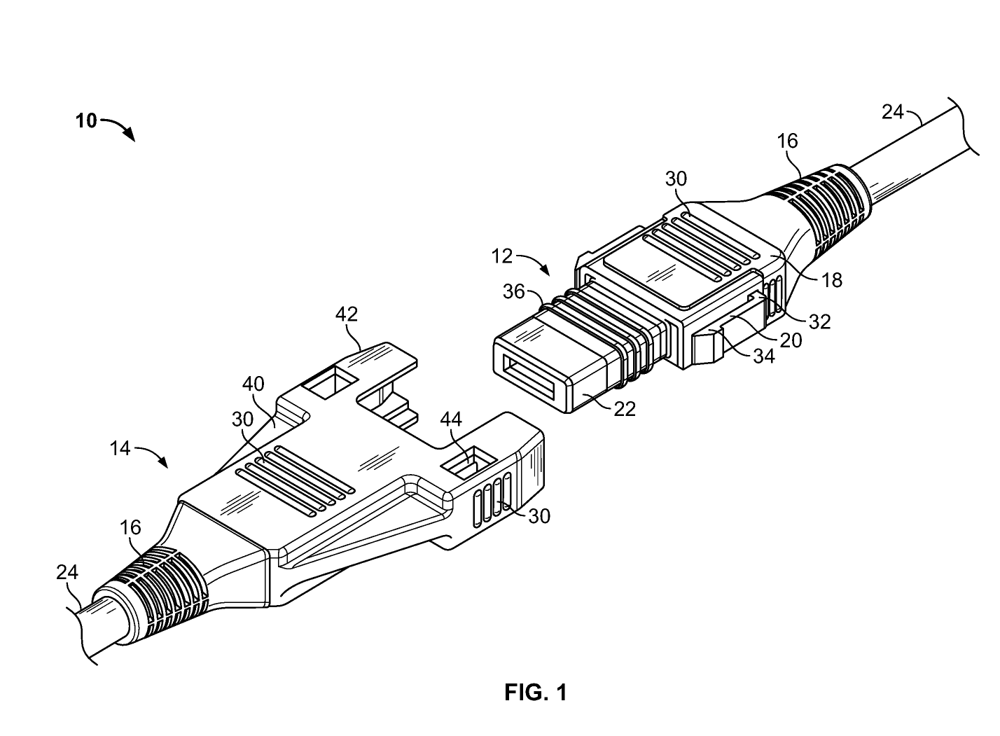

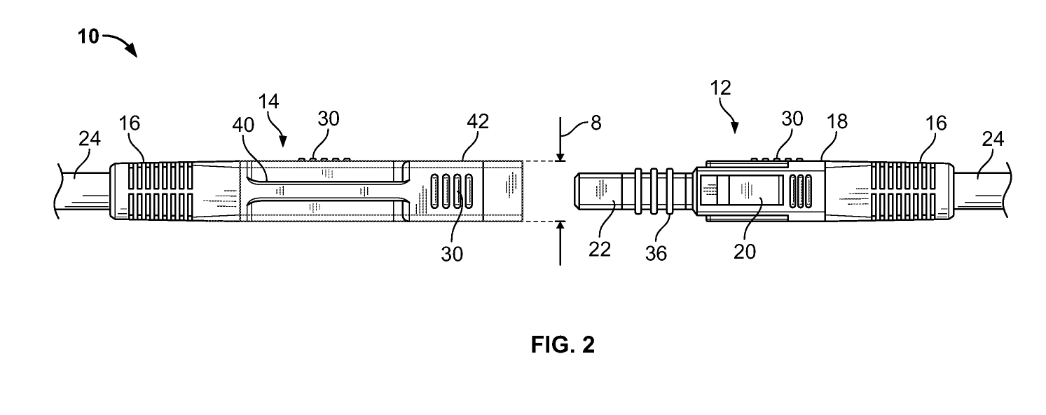

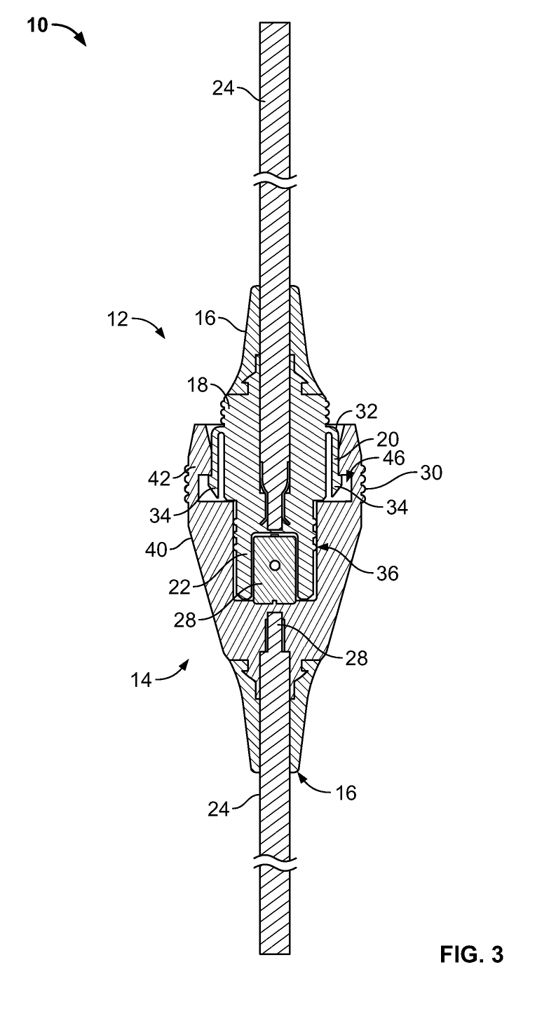

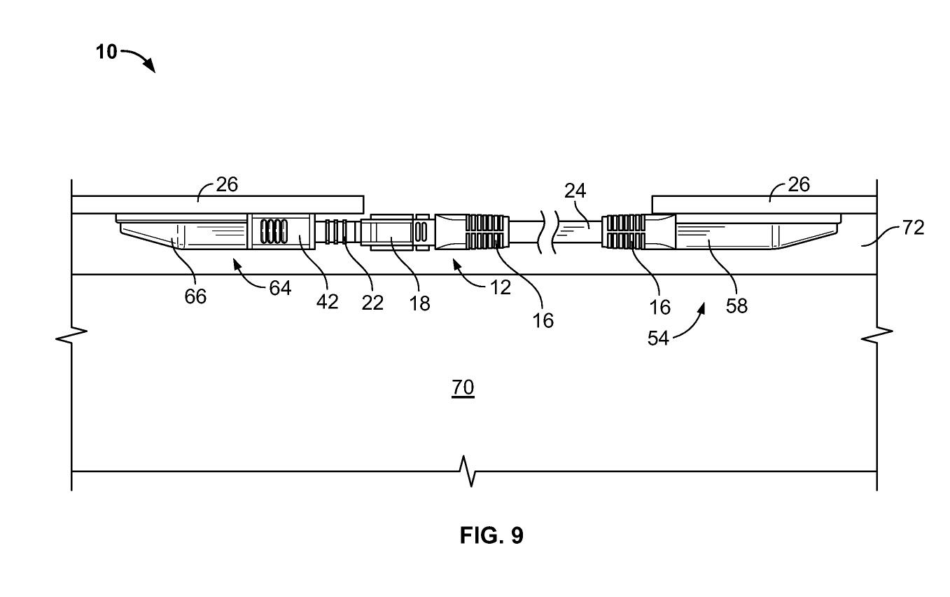

FIGS. 1, 2 and 3 show a low profile PV (LPPV) connector 10. Connector 10 has a plug 12 and a receptacle 14 that are mateable to form an electrical connection. Plug 12 includes a strain relief 16, a body 18, locking latches 20, and a male connection 22. Strain relief 16 provides a waterproof seal and relieves strain caused by pulling and bending of a cable 24 that extends from plug 12 or receptacle 14. Strain relief 16 may be manufactured from a flexible and sturdy material such as Santoprene® rubber, or any other suitable material. Cable 24 conducts power from a solar array 26 (see FIG. 9) to plug 12. While a solar array 26 is described as the source of power conducted by cable 24, it is appreciated that cable 24 may range from a 14 AWG cable to a 10 AWG cable and may communicate power or data from any source to plug 12 or receptacle 14. Plug 12 and receptacle 14 are limited in vertical elevation by the width of cable 24 used with connector 10. A five (5) millimeter cable may be used with connector 10, however it is appreciated that any cable may be used with connector 10, including but not limited to, ribbon cable.

Plug body 18 extends from strain relief 16, and is manufactured from a rigid plastic material or any other suitable material. Plug 12 may be formed by an overmolding process, or any other suitable manufacturing process. Disposed inside plug body 18 is a contact, or blade 28 for facilitating an electrical connection with receptacle 14. Blade 28 may be a faston blade or any other suitable blade or contact. Plug body 18 may also include a grip 30 on the top surface to provide a non-slippery surface for a user to grasp plug 12. Grip 30 may be molded from the same material, or grip 30 may be molded from the same flexible material as strain relief 16. Disposed on both sides of body 18 are locking latches 20. Locking latches 20 extend from plug body 18 and bend at an elbow 32 to extend substantially parallel to body 18. Locking latches 20 have protrusions 34 at the distal end of latch 20. Protrusions 34 engage with receptacle 14 when plug 12 is mated with receptacle 14.

Extending from body 18 is male connection 22. Male connection 22 mateably connects with receptacle 14. Sealing ribs 36 are disposed on the outer surface of male connection 22. The figures show three sealing ribs 36 disposed on the outer surface of male connection 22, however any suitable number of sealing ribs 36 may be used. Sealing ribs 36 may be formed from a flexible material such as Santoprene® rubber, or any other suitable slightly compressible material. When plug 12 is mated with receptacle 14, sealing ribs 36 are compressed against receptacle to form a seal between plug 12 and receptacle 14. Sealing ribs 36 prevent moisture, dust particles or other matter from entering connector 10.

Receptacle 14 has a strain relief 16 extending from one end of a receptacle body 40 and a female connection receiver 42 opposite strain relief 16 for receiving plug 12. Strain relief 16 provides waterproof protection and strain relief to a cable 24 that extends from receptacle 14. Cable 24 communicates solar power and energy from a solar array 26 (see FIG. 9) to receptacle 14. While a solar array 26 is described, it is appreciated that cable 24 may communicate power or data from other sources and is not limited to solar arrays. Strain relief 16 may be manufactured from a flexible and sturdy material such as Santoprene® rubber, or any other suitable material.

Receptacle body 40 extends from strain relief 16, and is manufactured from a rigid plastic material or any other suitable material. Receptacle 14 may be formed by an overmolding process, or any other suitable manufacturing process. Disposed inside receptacle body 40 is a contact, or blade 28 for facilitating an electrical connection with blade 28 in plug 12. Blade 28 may be a faston blade or any other suitable blade or contact. Receptacle body 40 may also include a grip 30 on the top surface to provide an abrasive surface for a user to grasp receptacle 14. Grip 30 may be unitary with receptacle body 40 and molded from the same material, or grip 30 may be molded from the same flexible material as strain relief 16.

Extending from receptacle body 40 is receiver 42. Receiver 42 is unitary with receptacle body 40 and configured to mate with male connection 22 on plug 12. Disposed on each side surface of receiver 42 are grips 30 to provide an abrasive surface for a user to grasp receptacle 14. Grip 30 may be molded from the same material as receptacle body 40, or grip 30 may be molded from the same flexible material as strain relief 16. Apertures 44 are disposed on opposites sides of receiver 42. Apertures 44 are configured and disposed to align with protrusions 34 on locking latches 20 when plug 12 is mated with receptacle 14. Apertures 44 provide access to locking latches 20 when plug 12 is mated with receptacle 14. Receiver 42 also includes a ledge 46. Ledge 46 engages locking latch 20 when plug 12 is mated with receptacle 14. Protrusions 34 engage with ledges 46 and maintain plug 12 engagement with receptacle 14. When locking latches 20 engage with ledges 46, an audible and/or tactile signal may notify the user that plug 12 is secured in receptacle 14.

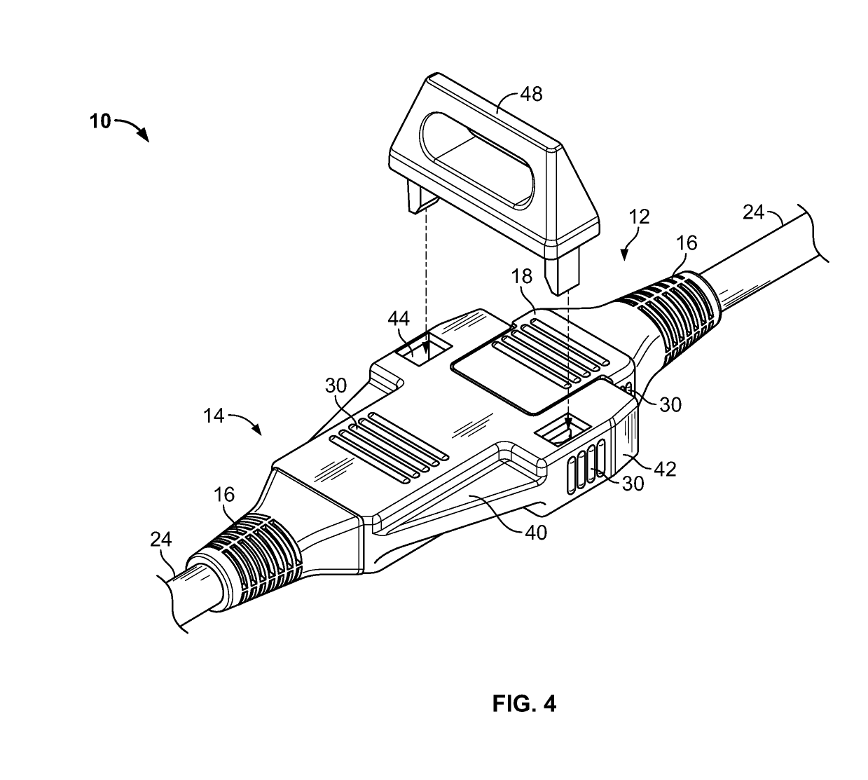

As shown in FIG. 4, an extraction tool may be used to disengage locking latches 20 from ledges 46. Extraction tool 48 may be inserted into apertures 44 and contact protrusions 34, to disengage locking latches 20 from ledges 46. When extraction tool 48 displaces locking latches 20, elbow 32 permits movement of locking latches 20 to disengaged protrusions 34 from ledges 46. Plug 12 may be removed from receptacle 14 when extraction tool 48 has disengaged locking latches 20 from ledges 46. Both plug 12 and receptacle 14 of connector 10 are configured not to exceed a maximum height of 8 mm. However, connector 10 may be configured within any suitable height requirement.

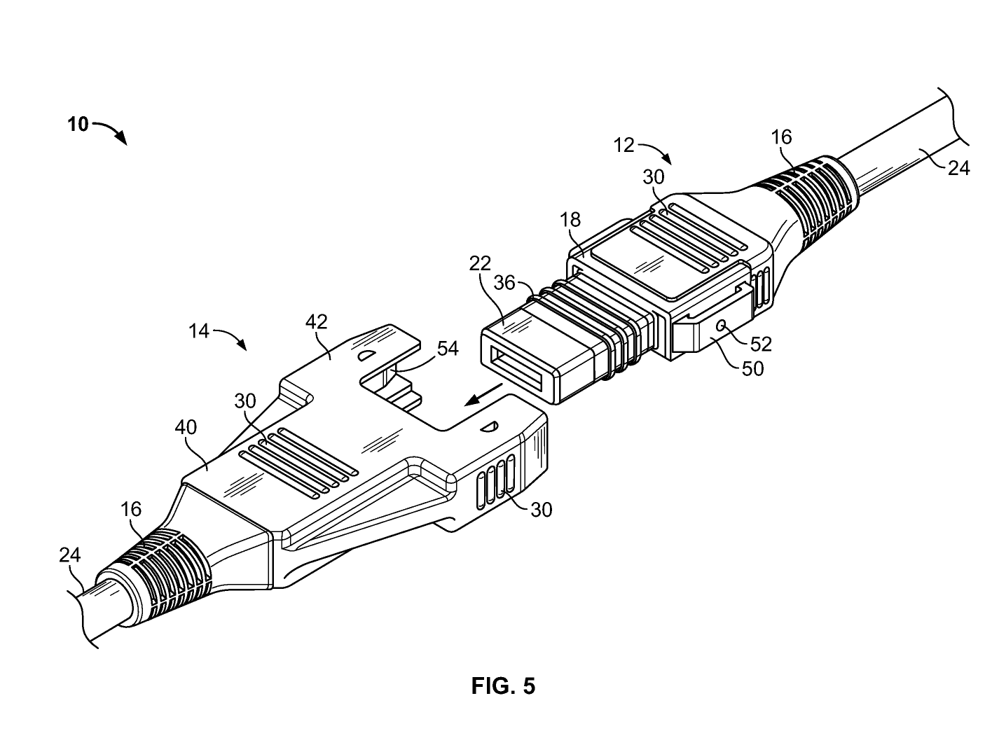

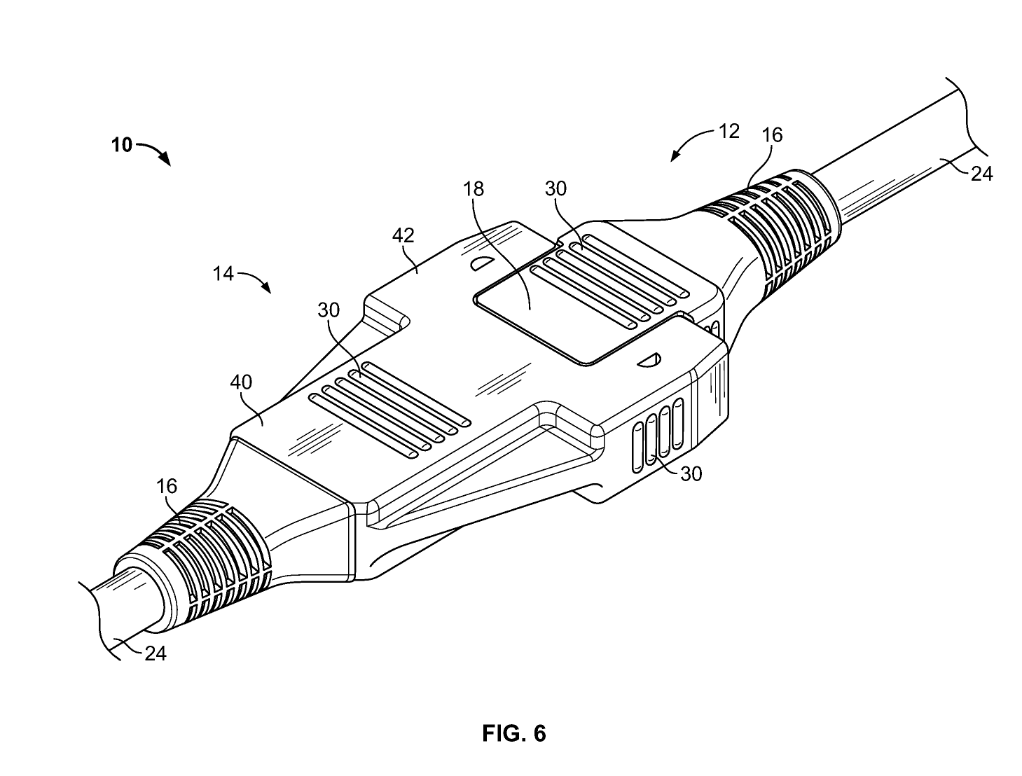

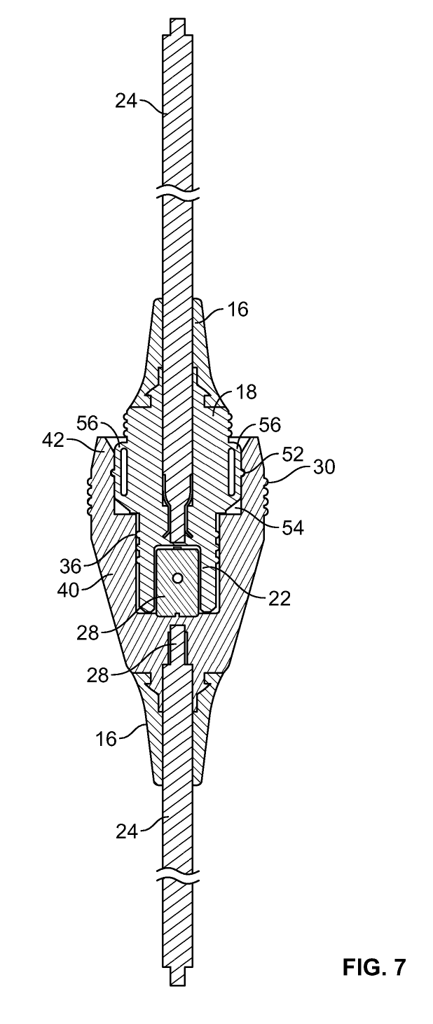

In an alternate embodiment shown in FIGS. 5, 6, and 7, plug 12 may include at least one engaging latch 50. Engaging latch 50 extends outward from body 18 of plug 12 and has a projection 52. Engaging latch 50 is deformable, as plug 12 is mated with receptacle 14, engaging latch 50 may be displaced inward toward body 18 until projection 52 engages with cavity 54 in receiver 42 in receptacle 14. When engaging latches 50 engage with receiver 42, an audible and/or tactile signal may notify the user that plug 12 is secured in receptacle 14. Once plug 12 is mated with receptacle 14, plug 12 may be removed from receptacle 14 without the aid of a tool or other device. A normal force of about twenty pounds or greater may be applied to plug 12, receptacle 14, or both substantially simultaneously to remove plug 12 from receptacle 14. Receptacle body 40 of receiver 14 may not include apertures 44 (see, e.g. FIG. 1). An extraction tool 48 (FIG. 4) or other removal device is unnecessary to remove plug 12 from receptacle 14.

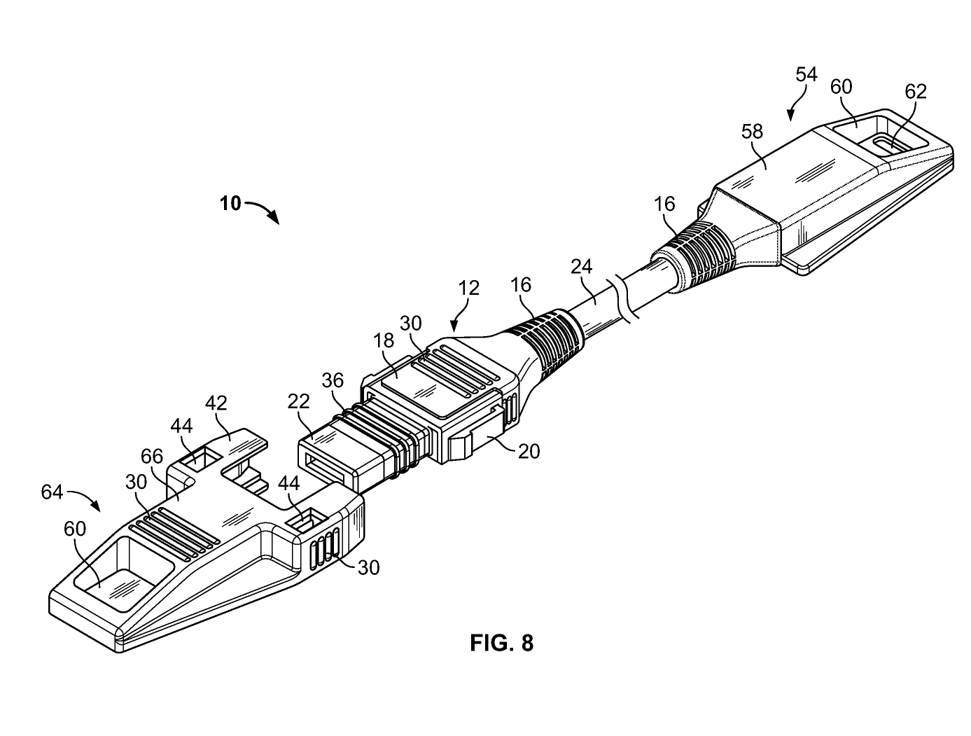

In another alternate embodiment shown in FIG. 8, connector 10 is used with a junction box 54. Plug 12 is in communication with junction box 54 through cable 24. Junction box 54 may be an LPPV junction box, or any other suitable junction box and may include a body 58, strain relief 16, and a solder pad 60. An adhesive is used to mount and secure body 58 of junction box 54 to a solar array 26 (see FIG. 9) or other suitable device. Junction box 54 is disposed on solar array 26 (FIG. 9) such that a conductive foil (not shown) on solar array 26 contacts solder pad 60 on junction box 54. Conductive foil (not shown) is used to provide electrical interconnections between multiple solar arrays 26. Conductive foil (not shown) may be unitary with, or in communication with solar array 26, and extend from solar array 26 to enable a connection with junction box 54 or other suitable connection device. Solder pad 60 has a slot 62 for soldering solder pad 60 to a conductive foil (not shown). Once foil (not shown) has been soldered to solder pad 60, an epoxy or other seal or filling (not shown) is applied to solder pad 60. The epoxy (not shown) prevents external objects or elements from damaging solder pad 60 and from damaging the soldered connection between solder pad 60 and foil (not shown). Plug 12 may also be a locking plug 12 as described above with reference to FIGS. 1, 2, 3 and 4, above, or plug 12 may be a non-locking plug 12 as described with reference to FIGS. 5, 6, and 7, above.

Receptacle 64 is mateable with plug 12 and may include a body 66, solder pad 60, and receiver 42. An adhesive is used to mount and secure body 66 of receptacle 64 to a solar array 26 (see FIG. 9) or other suitable device. Receptacle 64 is disposed on solar array 26 such that a conductive foil (not shown) on solar array 26 contacts solder pad 60 on receptacle 64. Solder pad 60 has a slot 62 for soldering solder pad 60 to foil (not shown). Once a solder connection has been made between foil (not shown) and solder pad 60, an epoxy or other seal or filling (not shown) is applied to solder pad 60. The epoxy (not shown) prevents external objects or elements form damaging solder pad 60 and from damaging the soldered connection between solder pad 60 and foil (not shown). Receiver 42 receives plug 12 and secures plug 12 in receptacle 64. Receptacle 64 may be a locking receptacle as described with reference to FIGS. 1, 2, 3, and 4, above, or receptacle 64 may be a non-locking receptacle as described with reference to FIGS. 5, 6 and 7, above.

FIG. 9 shows connector 10 with junction box 54 mounted and secured to solar array 26. Solar arrays 26 are mounted to a roof 70 or other suitable location, were solar arrays 26 may gather solar energy and power. Junction box 54 is mounted to a first solar array 26 when body 58 is secured to solar array 26 with an adhesive. Receptacle 64 is mounted to a second solar array 26 when body 66 is secured to solar array 26 with an adhesive. A small air gap 72 between roof 70 and connector 10 and solar arrays 26 provide space for a user to access solar arrays 26 and/or connector 10 if necessary. Connector 10 facilitates communication or power transfer between the first and second solar arrays 26. A plurality of connectors 10 may be used to connect a plurality of solar arrays 26.

Both a locking LPPV connector 10 and a non-locking LPPV connector 10 are shown in FIGS. 1 through 9. It is appreciated that the locking and non-locking LPPV connectors 10 may be interchanged within applications. It is also appreciated that a locking LPPV connector 10 may be required for certain applications by standards known to those of ordinary skill in the art.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A low profile connector comprising:
a plug comprising a strain relief, a plug body, a male connection and a cable; and
a receptacle comprising a strain relief, a receptacle body and a receiver;
wherein the plug is matable with the receptacle to form an electrical connection, and wherein when the plug and receptacle are mated, the plug is not removable from the receptacle and wherein the plug and the receptacle have a vertical profile not greater than a width of the cable.

2. The low profile connector of claim 1, wherein the plug body comprises at least one latch, the at least one latch configured to engage with at least one ledge in the receiver and prevent the plug and receptacle from unmating once the plug and receptacle are mated.

3. The low profile connector of claim 1, wherein an extraction tool is used to remove the plug from the receptacle once the at least one latch has engaged with the at least one ledge.

4. The low profile connector of claim 2, wherein the receptacle comprises at least one aperture, the at least one aperture configured to provide access to the at least one latch when the plug is mated with the receptacle.

5. The low profile connector of claim 3, wherein the extraction tool is placed in the at least one aperture and wherein the extraction tool disengages the at least one latch from the at least one ledge and releases the plug from the receptacle.

6. The low profile connector of claim 1, wherein the plug and the receptacle are manufactured from an overmolding process.

7. The low profile connector of claim 1, wherein the plug is in communication with a first solar array and the receptacle is in communication with a second solar array and when the plug is mated with the receptacle, the first solar array is in communication with the second solar array.

8. The low profile connector of claim 7, wherein the plug is in communication with the first solar array through a cable and the receptacle is in communication with the second solar array through a cable.

9. The low profile connector of claim 8, wherein the cables are 14-10 AWG capable and eight millimeters in diameter.

10. The low profile connector of claim 1, wherein the plug comprises at least one sealing rib, the sealing rib configured to provide a waterproof seal when the plug and the receptacle are mated.

11. The low profile connector of claim 1, wherein the plug produces at least one of an audible and tactile signal when the plug is mated with the receptacle.

12. A low profile connector comprising:
a plug and a receptacle, the plug and receptacle configured to mate and form an electrical connection;
the plug comprising a strain relief, a plug body, a male connection and a cable, the plug body comprising at least one latch; and
the receptacle comprising a strain relief, a receptacle body and a receiver, the receiver comprising at least one ledge, the at least one ledge configured to engage with the at least one latch;
wherein the plug and the receptacle have a vertical profile not greater than a width of the cable.

13. The low profile connector of claim 12, wherein the plug is not removable from the receptacle when the plug and the receptacle are mated.

14. The low profile connector of claim 13, wherein the receptacle comprises at least one aperture, the at least one aperture configured to provide access to the at least one latch when the plug is mated with the receptacle.

15. The low profile connector of claim 14, wherein an extraction tool is placed in the at least one aperture and wherein the extraction tool displaces the at least one latch and releases the plug from the receptacle.

16. The low profile connector of claim 12, wherein the plug is removable from the receptacle when at least twenty pounds of force are applied to at least one of the plug and the receptacle.

17. The low profile connector of claim 12, wherein the plug and the receptacle are manufactured from an overmolding process.

18. The low profile connector of claim 12, wherein the plug is in communication with a first solar array and the receptacle is in communication with a second solar array and when the plug is mated with the receptacle, the first solar array is in communication with the second solar array.

19. The low profile connector of claim 12, wherein the plug comprises at least one sealing rib, the sealing rib configured to provide a waterproof seal when the plug and receptacle are mated.

20. The low profile connector of claim 12, wherein the plug produces at least one of an audible and tactile signal when the plug is mated with the receptacle.
